(19) United States
(12) Patent Application Publication
(10) Pub. No.: US 2026/0205176 A1
(43) Pub. Date: Jul. 16, 2026

(54) METHOD AND APPARATUS FOR BEAM MANAGEMENT BASED ON RADAR SENSING INFORMATION

(71) Applicants: Samsung Electronics Co., Ltd., Suwon-si (KR); Seoul National University R&DB Foundation, Seoul (KR)

(72) Inventors: Jeonghyeon JANG, Suwon-si (KR); Byonghyo SHIM, Seoul (KR); Hyunsoo KIM, Seoul (KR)

(21) Appl. No.: 19/451,975

(22) Filed: Jan. 16, 2026

(30) Foreign Application Priority Data
Jan. 16, 2025 (KR) 10-2025-0006926

(51) Int. Cl. H04B 7/06; H04B 7/08; H04W 64/00

(52) U.S. Cl. CPC H04B 7/0617; H04B 7/082; H04W 64/00

(57) ABSTRACT

The disclosure is related to 5G or 6G communication systems for supporting higher data transfer rates than 4G communication systems such as LTE. A method performed by a base station in a wireless communication system may include: acquiring radar sensing information for a user equipment (UE); acquiring path component information for at least one path between the UE and the base station, based on the radar sensing information; selecting a first path, based on the acquired path component information for the at least one path and movement information of the UE; determining a first beamforming vector, based on path component information corresponding to the first path; and performing communication by using a beam formed based on the first beamforming vector.

### CROSS-REFERENCE TO RELATED APPLICATION

This application is based on and claims priority under 35 U.S.C. § 119 to Korean Patent Application No. 10-2025-0006926, filed on Jan. 16, 2025, in the Korean Intellectual Property Office, the disclosure of which is herein incorporated by reference in its entirety.

### BACKGROUND

### 1. Field

The disclosure relates to a wireless communication system and, more particularly, to a method and an apparatus for beam management in a wireless communication system.

### 2. Description of Related Art

Considering the development of wireless communication from generation to generation, the technologies have been developed mainly for services targeting humans, such as voice calls, multimedia services, and data services. Following the commercialization of 5th generation (5G) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple-input multiple-output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the disclosure. No determination has been made, and no assertion is made, as to whether any of the above might be applicable as prior art with regard to the disclosure.

### SUMMARY

The disclosure may provide a new beam management method having improved beamforming performance in a wireless communication system and capable of minimizing pilot overhead.

A method performed by a base station according to an embodiment of the disclosure may include: acquiring radar sensing information regarding a terminal; acquiring path component information regarding at least one path between the terminal and the base station, based on the radar sensing information; selecting a first path, based on the acquired path component information regarding at least one path and movement information of the terminal; determining a first beamforming vector, based on path component information corresponding to the first path; and performing communication by using a beam formed based on the first beamforming vector.

A base station according to an embodiment of the disclosure may include a transceiver; and a controller connected to the transceiver, wherein the controller is configured to: acquire radar sensing information regarding a terminal; acquire path component information regarding at least one path between the terminal and the base station, based on the radar sensing information; select a first path, based on the acquired path component information regarding at least one path and movement information of the terminal; determine a first beamforming vector, based on path component information corresponding to the first path; and perform communication by using a beam formed based on the first beamforming vector.

A radar sensing information-based beam management method of the disclosure may provide a beam management method having an improved beamforming performance in a wireless communication system.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a beamforming communication scheme according to various embodiments of the present disclosure;

FIG. 2 illustrates a LOS path and an NLOS path according to various embodiments of the present disclosure;

FIG. 3 illustrates a beam management method based on radar sensing information according to various embodiments of the present disclosure;

FIG. 4 illustrates a flowchart of a beam management method based on radar sensing information of a base station according to various embodiments of the present disclosure;

FIG. 5 illustrates a flowchart of a procedure for restoring a beam according to beam failure detection according to various embodiments of the present disclosure;

FIG. 6 illustrates a method of predicting path blockage of a base station according to various embodiments of the present disclosure;

FIG. 7 illustrates a method of a base station to determine the range and speed of a UE based on radar sensing information according to various embodiments of the present disclosure;

FIG. 8 illustrates a method of a base station to determine a range-Doppler map (RDM) regarding the range and speed of a UE based on radar sensing information according to various embodiments of the present disclosure;

FIG. 9 illustrates a method of a base station to determine the time delay and Doppler shift regarding each of at least one path based on a range-Doppler map according to various embodiments of the present disclosure;

FIG. 10 illustrates a flowchart of a procedure of a base station to acquire path component information regarding at least one path between a base station and a UE based on radar sensing information regarding the UE according to various embodiments of the present disclosure;

FIG. 11 illustrates performance improvement of a beam management method based on radar sensing information according to various embodiments of the present disclosure;

FIG. 12 illustrates performance improvement of a beam management method based on radar sensing information according to various embodiments of the present disclosure;

FIG. 13 illustrates a beam management method of a UE based on radar sensing information according to various embodiments of the present disclosure;

FIG. 14 illustrates an example of a structure of a UE according to various embodiments of the present disclosure; and

FIG. 15 illustrates an example of a structure of a base station according to various embodiments of the present disclosure.

### DETAILED DESCRIPTION

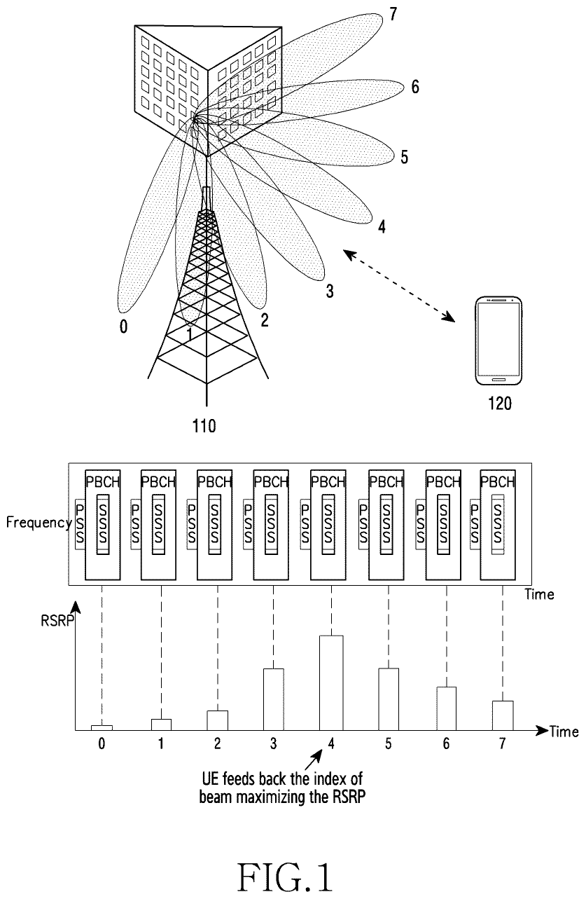

FIGS. 1 through 15, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size thereof. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE, LTE-A, or 5G systems may be described by way of example, but the embodiments of the disclosure may also be applied to other communication systems having similar technical backgrounds or channel types. Examples of such communication systems may include the 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, long-term evolution (LTE) or evolved universal terrestrial radio access (E-UTRA)), LTE-advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS, eNode B, or gNode B), and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be performed to be improved. Also, the data rate required for the 5G communication system may be obtained using a frequency bandwidth more than 20 MHz in a frequency band of 3 to 6 GHz or 6 GHz or above, instead of transmitting signals using a transmission bandwidth up to 20 MHz in a band of 2 GHz used in LTE.

In addition, mMTC is considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery lifetime such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In 5G, a codebook-based beam management method has been introduced to increase the system capacity. The codebook-based beam management method may include at least one of a beam sweeping process in which the base station sequentially transmits multiple directional beams to determine a beam through which the UE may receive the strongest signal, a beam selection process in which the UE selects a beam that provides the strongest signal and reports the same to the base station, a beam refinement process in which the base station sweeps a narrower beam in a narrower range, based on the selected beam, to determine an optimal beam, or a process of tuning the UE's receiver while the optimal beam is repeatedly transmitted by the base station. The codebook may refer to a set of weight vectors of signals used to adjust the phase and amplitude of signals transmitted by each antenna in order to transmit a signal in a specific direction in a beamforming system.

In the beam sweeping process, the base station may sequentially transmit a synchronization signal block (SSB) to the UE by using a 2D-DFT-based codebook. In the beam selection procedure, the UE may feedback the beam index of a beam in the direction in which the received signal magnitude is maximum, to the base station. In the beam refinement process, the base station may transmit multiple CSI-RSs with reference to the beam selected in the beam sweeping process, and determine an optimal beam, based thereon.

Additionally, the codebook-based beam management method may further include a beam failure and recovery procedure. In the codebook-based beam management method, the UE may detect a beam failure by determining whether a connected beam satisfies a beam failure condition. For example, the UE may determine that a beam failure has occurred in case that the magnitude of a reference signal of a connected beam (e.g., layer 1 reference signal received power (L1-RSRP)) becomes lower than a threshold. To this end, the UE may monitor the magnitude of a reference signal of a connected beam. In case that a beam failure occurs, the UE may identify or search for a new candidate beam through a beam recovery procedure, and then initiate a beam recovery request. The UE may transfer information for a beam recovery request, including a UE identifier and information on a new candidate beam, to a new base station. Thereafter, the UE may monitor a search space to receive a response to the base station's beam recovery request, and the response may be transmitted via the new transmission beam identified by the UE. For example, in case that a beam failure occurs in a control channel, the UE may, after transmitting a beam recovery request to the base station, monitor a control channel search space to receive a response to the beam recovery request.

However, the codebook-based beam management method may be effective in frequencies of 6 GHz or less (e.g., 410 MHz to 7.125 GHz or FR1), but has two main problems in millimeter wave (mmWave, FR2) frequencies.

First, mmWave signals using mmWave frequencies have strong directivity or low diffraction. The mmWave signals provide a much higher data transmission rate than signals having frequencies of 6 GHz or less, but are very sensitive to attenuation, interference, and link blockage caused by UE movements or obstacles (automobiles, walls, and buildings) and have a large path loss due to the strong directivity. In particular, the codebook-based beam management method may have a limitation in adaptively updating the codebook in response to the attenuation, interference, and link blockage, because the method uses a finite number of beam codewords. Therefore, according to the codebook-based beam management method, an error or beam misalignment between the direction of a beam (or the direction of a transmitted signal) and the actual direction of the UE (or the actual direction of a received signal) is liable to occur. This may lead to a decrease in beamforming gain. For example, in case that an 8×8 planar array antenna has an oversampling ratio of 4 (i.e., 32×32 beams are used), a beam error of approximately 4 degrees may occur, which may cause a beamforming gain decrease of approximately 20%. In particular, in the case of a communication system that requires a high data transmission rate and a stable communication link in order to support cutting-edge applications such as vehicle to everything (V2X) communication, factory automation, autonomous driving, and remote surgery, a new beam management method may be required to maintain a stable communication link despite the movement of the UE or interference from obstacles.

Second, according to the codebook-based beam management method, the overhead due to beam training may reduce the overall resource utilization and lower the data transmission rate. Specifically, the codebook-based beam management method may involve beam training such that the base station and/or the UE perform beam sweeping to find an optimal beam pair. The beam training overhead may increase in proportion to the number of beams used for beam sweeping by the base station and/or the UE, and in proportion to the rate of movement of the UE in the environment in which the UE moves. In addition, the beam training overhead may also include an overhead due to a reference signal used in the beam training process.

Third, according to the codebook-based beam management method, reference signal transmission/reception and signal quality measurement may be performed for beam recovery in case that a beam failure occurs, and beam failure detection and beam recovery may result in a pilot overhead and a delay time. For example, the base station and the UE may transmit/receive reference signals in order to measure the signal quality for beam failure detection and beam recovery and to acquire synchronization/channel state information, and this may not only consume RF resources and hardware resources, but also result in a pilot overhead and a delay time. For example, if four CSI-RSs are transmitted in the mmWave band 5G NR beam improvement process, the delay time is about 30 ms. This delay time exceeds the coherence time (9 ms) when the UE is moving at a speed of 30 km/h, the direction of the beam and the direction of the UE are thus mismatched, the efficiency of the communication system may accordingly degrade. Therefore, a new beam management method capable of accurately forming a beam in the direction of the UE while minimizing the pilot overhead may be necessary.

The disclosure may replace the beam refinement process and the beam recovery process of the codebook-based beam management method with a beamforming process based on radar sensing information. As a result, the disclosure may provide beam management method which solves the beam mismatch problem due to the limited number of beam codewords by forming a beamforming vector by using laser sensing information instead of a codebook in the beam refinement process and the beam recovery process, and which is also useful in the mm Wave band. In addition, the disclosure may perform beamforming by using radar sensing information which is more accurate than beam management information based on a reference signal, while minimizing the pilot overhead occurrence of or resource consumption involved in reference signal transmission/reception and measurement. In addition, unlike the codebook-based beam management method in which a beam failure is predicted based on a reference signal, the disclosure may predict the path of movement of the UE, based on radar sensing information, or may predict that the LoS path between the base station and the UE is blocked. In addition, the beam management method of the disclosure may also identify a UE on an NLOS path because it uses radar sensing information.

The beam management method based on radar sensing information according to the disclosure uses radar sensing information including information regarding the NLOS path such that, even if the LoS path of the UE is blocked, the location of the UE can be effectively detected.

The beam management method based on radar sensing information according to the disclosure forms a beam, based on radar sensing information, thereby providing a beamforming method which provides high directivity and gain, and which effectively operates.

The beam management method based on radar sensing information according to the disclosure detect whether a beam failure has occurred, based on radar sensing information, and performs beam recovery, thereby performing a fast and accurate beam failure recovery procedure.

The beam management method based on radar sensing information according to the disclosure may achieve a higher level of localization performance and throughput performance than a codebook-based beam management method.

Hereinafter, a method for beam management method on radar sensing information and a device therefor according to the disclosure will be described with reference to the drawings.

FIG. 1 illustrates a beamforming communication scheme according to various embodiments of the present disclosure.

FIG. 1 illustrates a base station 110 and a UE 120 as some nodes using radio channels in a wireless communication system. FIG. 1 illustrates one base station and one UE, but this is only an example. The wireless communication system in FIG. 1 may further include other base stations identical or similar to the base station 110 and other UEs.

The base station 110 is a network infrastructure that provides wireless access to the UE 120. The base station 110 has a coverage which is defined as a specific geographic area based on the signal transmission/reception range. The base station 110 may also be referred to as “access point (AP),” “evolved node B (eNB),” “next generation node B (gNB),” “5th generation (5G) node,” “wireless point,” “transmission/reception point (TRP),” or other terms having equivalent technical meanings, in addition to “base station.”

The UE 120 is a device used by the user, and may perform communication with the base station 110 through a radio channel. The UE 120 may be operated without the user's involvement. For example, the UE 120 may be a device which performs a machine type communication (MTC) and may not be carried by the user. The UE 120 may be referred to as “terminal,” “mobile station,” “subscriber station,” “customer premises equipment (CPE),” “remote terminal,” “wireless terminal,” “electronic device,” “user device,” or other terms having equivalent technical meaning, in addition to “user equipment (UE).”

The base station 110 and the UE 120 may transmit and/or receive radio signals in a millimeter wave (mmWave) band (e.g., 28 GHz, 30 GHz, 38 GHz, 60 GHz). In this case, in order to improve the channel gain, the base station 110 and/or the UE 120 may perform beamforming.

Beamforming may include transmission beamforming and/or reception beamforming. That is, the base station 110 and/or the UE 120 may assign directivity to transmitted signals or received signals. In order to assign directivity to received signals, the base station 110 and/or the UE 120 may select serving beams through a beam search or beam management or beam optimization procedure.

According to an embodiment, in order to select serving beams, the base station 110 may transmit a synchronization signal block (SSB) to the UE 120 by using beam sweeping. The SSB may include a primary synchronization signal (PSS) for time synchronization between a cell associated with the base station 110 and the UE 120, a secondary synchronization signal (SSS) for providing additional synchronization information, a physical broadcast channel (PBCH) for providing essential system information necessary for initial access, and a PBCH demodulation reference signal (DMRS) which is a reference signal used for channel estimation in order to accurately demodulate the PBCH. The UE 120 may identify the symbol timing and the frame boundary of the cell, based on the PSS. The additional synchronization information included in the SSS may include a cell ID associated with the base station 110 in the cell group, and the UE 120 may identify a cell associated with the base station 110 from other cells, based on the SSS. The PBCH may include a master information block (MIB) including essential system information such as a subcarrier spacing. Referring to FIG. 1, the base station 110 may transmit an SSB by using eight different beams 0, 1, 2, 3, 4, 5, 6, and 7. Upon receiving the SSB, the UE 120 may detect the presence of the base station 110, perform time and frequency synchronization, and acquire essential information necessary for connecting to the base station 110. The UE 120 may measure the reception power (e.g., RSRP) of the received SSB, and may report the index (e.g., 4 in FIG. 1) of the beam having the highest reception power to the base station 110.

In the codebook-based beam refinement procedure, the base station 110 may receive the beam index from the UE 120, and may identify beam 4 corresponding to beam index 4. The base station 110 may perform additional beam sweeping, based on beam 4. The base station 110 may perform beam sweeping with narrower beams in a narrower range associated with beam 4. The UE 120 may report the beam having the highest reception power among the narrower beams to the base station 110. The base station 110 may receive the report from the UE 120 and may make repeated transmissions to the UE 120 by using the reported beam. The UE 120 may tune the receiver of the UE, based on the beam repeatedly transmitted by the base station. After serving beams are selected, subsequent communication may be performed through resources that are quasi co-located (QCL) with resources used to transmit the serving beams.

As such, the base station 110 and the UE 120 may perform beam training to find an optimal beam pair, as described above. The overhead involved in beam training may reduce the overall resource utilization, thereby degrading the data transmission rate. In addition, an environment in which the UE is moving requires frequent beam training, and the beam training overhead may thus greatly increase. In the case of a system using a large number of beams, the number of RSRP measurements for finding an optimal beam pair may increase, thereby significantly increasing the beam training overhead. For example, in case that the base station 110 uses 64 beams and the UE 120 uses 8 beams, 512 measurements are performed to find the optimal beam pair between the base station and the UE, and the beam training-related overhead may increase in proportion to the performed measurements.

The base station 110 and the UE 120 of the disclosure may each be a transmitting apparatus, a transmitting node, a receiving apparatus, and/or a receiving node. For example, the base station 110 may transmit radio frequency (RF) signals to the UE 120. The base station 110 may receive RF signals from the UE 120. As another example, the UE 120 may transmit RF signals to the base station 110 or another network entities of the wireless communication system. The UE 120 may receive RF signals from the base station 110 or other network entities.

In addition, according to an embodiment, the UE 120 may detect a beam failure if the received power regarding a serving beam becomes equal to or less than a threshold. If a beam failure is detected, the UE 120 may search for or identify other candidate beams. The UE 120 may transmit a beam failure recovery request regarding other candidate beams or a physical random access channel (PRACH) to the base station 110. The UE 120 may receive a response to the beam failure recovery request or a random access channel (RACH) response from the base station 110. The UE 120 may receive downlink control information (DCI) from the base station 110.

In the codebook-based beam management method, the base station and the UE may quantize channel state information into a codeword included in a pre-defined codebook in order to accurately transfer channel state information. A difference may occur between the actual channel state and the channel state information quantized into a finite number of codewords. In addition, difference from the actual channel state may increase as the UE feedbacks the channel state information to the base station by using a limited number of bits. As a result, a beam quantization error, which is the difference between the actual channel state and the quantized channel state, occurs inevitably. The beam quantization error consumes additional time and resources to find an optimal beam, thereby degrading the communication performance, and the overhead may be increased by using additional feedback information to compensate for the error. The beam quantization error in a codebook-based beam management method may significantly reduce the system efficiency by reducing the beamforming gain and the decoding probability.

In the beam management method based on radar sensing information according to the disclosure, the base station 110 may determine a beamforming vector, based on the radar sensing information.

The radar sensing information in the disclosure may include sensing information acquired by using a sensor capable of detecting a LoS path and an NLOS path, such as a radio detection and ranging (RADAR). The radar according to an embodiment has a lower frequency band than sensors such as an RGB camera and a light detection and ranging (LiDAR), and thus may be robust against reflection, diffraction, and scattering.

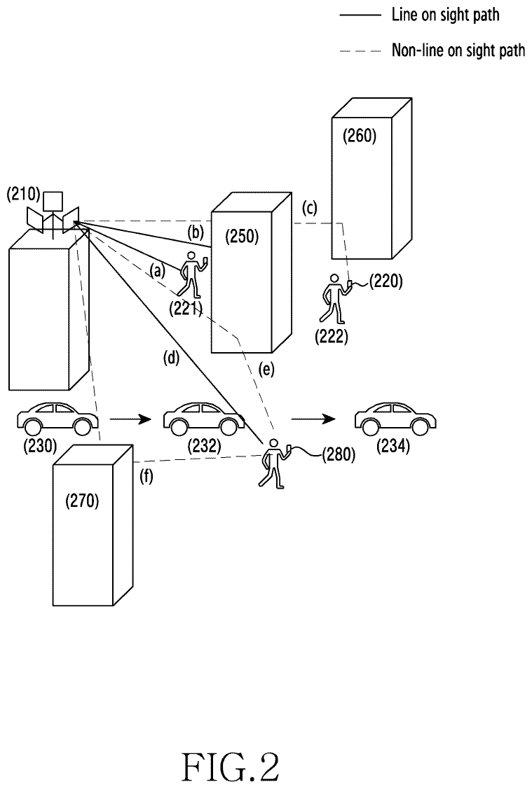

FIG. 2 illustrates a LOS path and an NLOS path according to various embodiments of the present disclosure.

According to various embodiments of the disclosure, a beam management method may acquire a path component regarding at least one path, based on radar sensing information. The base station may secure multiple candidate paths in preparation for a beam failure recovery, based on radar sensing information. The base station may predict that the LoS path of the UE may be blocked, and may directly form an alternative beam without an operation of measuring the UE's signal quality to detect a beam failure if the LoS path is blocked, a recovery request operation, the base station's beam sweeping operation for beam recovery, or a beam refinement operation, thereby improving link reliability.

Referring to FIG. 2, the base station 210 may perform communication with the UEs 220 and 280 inside the coverage of the base station through radio channels.

In a beam management method based on radar sensing information according to an embodiment, the base station may acquire radar sensing information from a radar. The base station may periodically acquire radar sensing information through the radar. For example, the radar may be a frequency-modulated continuous wave (FMCW) radar, may transmit a chirp signal the frequency of which continuously changes over time, and may receive a reflected signal (or radar echo). The radar sensing information may include radar sensing information regarding the UE and radar sensing information regarding the base station's surrounding environment. To this end, the radar may be disposed around the base station, and for example, the radar may be attached to the base station. The radar sensing information regarding the UE may be acquired based on a chirp signal reflected by the UE, and the radar sensing information regarding the base station's surrounding environment may be acquired based on chirp signals reflected by reflectors in the base station's surrounding environment.

In a beam management method based on radar sensing information according to an embodiment, the base station may acquire path components regarding at least one path between the base station and the UE, based on radar sensing information. The path components may include the time delay of the path of movement of a chirp signal, Doppler shift, and the angle of arrival. However, this is only an example and does not limit the disclosure. For example, the range may be determined based on the time delay, and the path components may thus further include the range or may include the range instead of the time delay. Alternatively, for example, the relative speed of a target (e.g., a moving UE) may be determined based on the Doppler shift, and the path components may thus further include the relative speed or may include the relative speed instead of the Doppler shift. Alternatively, the path components may further include the angle of departure of signals, or may include the angle of departure instead of the angle of arrival.

The base station may predict channel information of a LoS path and/or an NLOS path. The base station may acquire range information and speed information of a target or a path to the target by using radar sensing information, may determine channel information of an LoS path and/or channel information of a primary reflection path generated from a large reflector (e.g., a building, a wall, or a vehicle), and may form an optimal beam. The primary reflection path may refer to an NLOS path reflected once. The channel information of the LoS path and/or the NLOS path may be determined to determine a beamforming vector. For example, the base station 210 may acquire channel information of path c caused by the reflector 260 by using radar sensing information regarding the UE 220. Alternatively, the base station 210 may acquire channel information of path f caused by the reflector 270 by using radar sensing information regarding the UE 280.

To this end, the base station may acquire path components for one path between the base station and the UE. One path between a base station and a UE may be an LoS path or an NLOS path. Alternatively, the base station may acquire path components regarding multiple paths between the base station and the UE. The multiple paths may include one LoS path and one or more NLOS paths, or two or more NLOS paths. For example, the base station 210 illustrated in FIG. 2 may acquire radar sensing information regarding the UE 280 from the radar, and the radar sensing information regarding the UE 280 may include information regarding path d which is a LoS path, and information regarding path e and path f which are NLOS paths. The base station 210 may acquire a path component regarding path d, a path component regarding path e, and a path component regarding path f, based on radar sensing information regarding the UE 280.

According to an embodiment, the base station may determine location information and/or movement information of the UE, based on radar sensing information regarding the UE. The base station may predict path blockage and a beam failure caused thereby, based on location information and/or movement information of the UE, and form a beam corresponding to a different path. For example, the base station may predict the location of the UE, may predict that the LoS path may be blocked based on the predicted location of the UE, and may form a beam corresponding to the NLOS path.

The base station 210 may receive radar sensing information regarding the UE 220 when the UE 220 is at location 221, may acquire path components (e.g., time delay, Doppler shift, and angle of arrival) regarding path a to the UE 220, and form a first beam corresponding to path a, based on the path components. In addition, the base station 210 may acquire location information or movement information of the UE 220, based on radar sensing information regarding the UE 220, and may predict blockage of the first beam. Alternatively, based on radar sensing information regarding the UE 220 which is at location 222, the base station 210 may detect or identify that path b which is a LOS path regarding the UE 220 may be blocked. In case that the UE 220 at location 220 communicates with the base station through a first beam and then moves to location 222, the first beam being blocked by an obstacle 250, the base station 210 may form a second beam, based on a path component regarding the NLOS path (path c) regarding the UE 220, and may perform communication with the UE 220 through the second beam. In addition, the base station 210 may identify the location of the UE 220, even if blocked by the obstacle 250, by using radar sensing information. Accordingly, the base station may determine the UE's location more accurately and rapidly than in the case of performing beam recovery by using a beam sweeping procedure, without using a beam sweeping procedure using a beam having a narrow beam.

In addition, the base station 210 may receive radar sensing information regarding the UE 280, acquire a path component regarding path d to the UE 280, and form a third beam corresponding to path d. In addition, the base station 210 may acquire a path component regarding path e and/or path f to the UE 280, based on radar sensing information regarding the UE 280. In case that the UE 220 communicates with the base station 210 through a third beam, and in case that the third beam is blocked at location 230 by an obstacle moving from location 230 to location 234, the base station may identify that path d (LoS path) is blocked, based on radar sensing information. Path d and the third beam may correspond to each other. The base station may form a fourth beam corresponding to a path having a large path gain among path e and/or path f. Obviously, the above example is not limiting, and in case that beam blockage is expected according to the location or rate of movement of the UE, an NLOS path, not a LOS path, may be selected from the beginning.

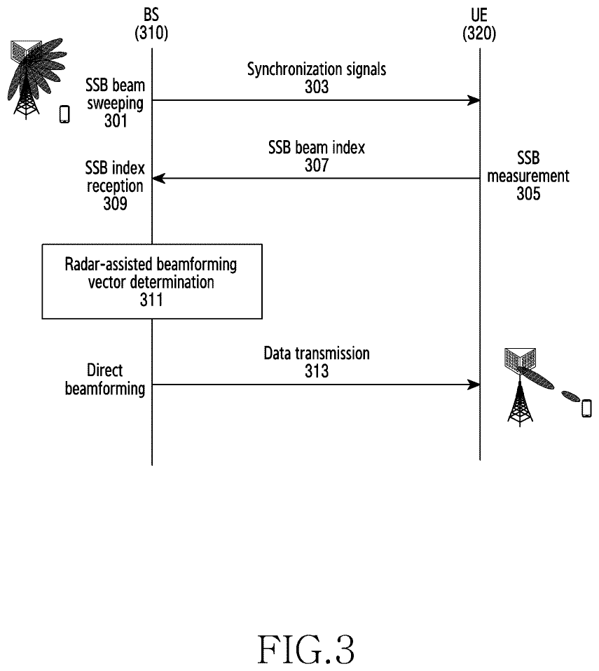

FIG. 3 illustrates a beam management method based on radar sensing information according to various embodiments of the present disclosure.

In steps 301 and 303, the base station 310 may transmit a synchronization signal block (SSB) to the UE 320 through SSB beam sweeping. Referring to FIG. 1, the base station may transmit an SSB by using eight different beams 0, 1, 2, 3, 4, 5, 6, and 7. Upon receiving the SSB, the UE 320 may detect the presence of the base station 310, perform time and frequency synchronization, and acquire essential information necessary to connect to the base station 310.

The UE 320 may perform SSB measurement to measure the reception power of the SSB received in step 305, and may report the SSB beam index of the beam having the highest reception power to the base station in step 307. Specifically, the UE may perform a random access procedure through a physical random access channel (PRACH), based on a resource mapped to the SSB having the largest signal magnitude among SSBs received from the base station. Specifically, the UE may transmit a preamble scrambled with an RA-RNTI to the base station through the PRACH (Msg. 1). The PRACH may include an SSB beam index. The base station 310 may receive a PRACH including an SSB beam index in operation 309, and transmit a random access response (RAR).

In a codebook-based beam management method, a base station and a UE may perform the following beam refinement procedure. Based on the SSB beam index received in step 309, the base station performs beam sweeping with beams having a narrower angle in a narrower range, and transmits a channel state information reference signal (CSI-RS) to the UE. The UE receives the CSI-RS, measures the channel state, determines an optimal beam based on the same, and then feedbacks information regarding the optimal beam to the base station.

However, according to a beam management method according to an embodiment of the disclosure, a beam refinement procedure based on a CSI-RS may be replaced with a beam vector determination procedure based on radar sensing information, thereby maximizing the data transmission rate while minimizing the loss of throughput and beamforming gain. Referring to FIG. 3, instead of performing beam refinement based on a CSI-RS, the base station 310 may determine an accurate beamforming vector based on radar sensing information in step 311, may perform beamforming based on the determined beamforming vector, and may perform communication with the UE in step 313 through the formed beam.

Although FIG. 3 illustrates only the base station 310 transmitting downlink data to the UE 320, the base station 310 and the UE 320 may perform both uplink and downlink data transmissions without being limited thereto. For example, the base station may perform beamforming for downlink or uplink transmission, based on the path components acquired in step 311 and the UE's location information.

In step 313, the base station may further perform scheduling with regard to the frequency and time. For example, the base station may form a beam in a specific direction, and then assign a frequency band and a time slot corresponding to the beam direction to the UE, thereby optimizing the communication quality.

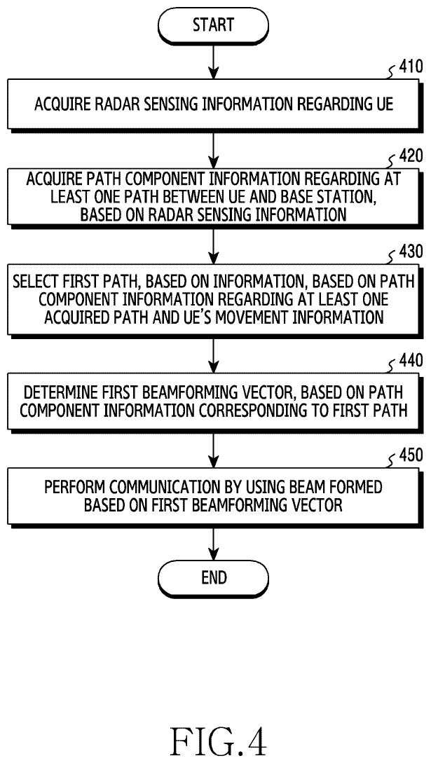

FIG. 4 illustrates a flowchart of a beam management method based on radar sensing information of a base station according to various embodiments of the present disclosure.

Referring to FIG. 4, the base station may determine a beamforming vector, based on channel information of an LOS path and/or an NLOS path, and may perform communication.

In step 410, the base station may acquire radar sensing information regarding the UE. Specifically, the base station may acquire a reflected signal of a radar signal with regard to the surrounding environment by using a radar sensor. The base station may acquire radar sensing information, based on a signal acquired by using the radar sensor.

The base station may acquire range information and speed information, based on radar sensing information. In the disclosure, the range information and speed information acquired by the base station, based on the radar sensing information, may include the UE's range-Doppler map (RDM) range-speed response pattern, a radar signal matrix R, and a point cloud P.

According to an embodiment, the range information and speed information may include a two-dimensional matrix configured by a range-speed or range-Doppler frequency axis (hereinafter, referred to as a “radar signal matrix R”). The elements of the radar signal matrix R may indicate the power of a signal corresponding to a specific range and Doppler frequency.

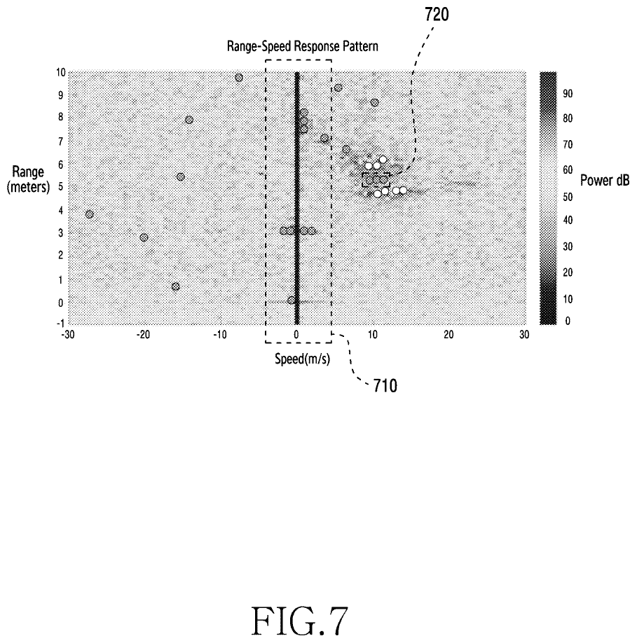

In addition, according to an embodiment, the range information and speed information may include a set of points in which range-speed information and information regarding the power of reflected signals are expressed in a three-dimensional space (hereinafter, referred to as a “point cloud P”). The point cloud P may include points having a range-speed value and a signal magnitude value expressed on the range-speed response pattern illustrated in FIG. 7. The base station may extract a radar signal matrix R and/or a point cloud P from the radar signal. The base station may perform pre-processing of signals received from the radar in order to acquire radar sensing information.

In addition, according to an embodiment, the range information and speed information may include a range-Doppler map (RDM). In this case, the base station may generate a range-Doppler map, based on the radar sensing information. The range-Doppler map may include a data structure that visually expresses the range and speed of an object at the same time in a radar system. The range-Doppler map may include information regarding a UE that is separated by a specific range and is moving at a specific speed, and information regarding a background that is separated by a specific range and is not moving. The base station may identify the location and speed of a moving UE by using the range-Doppler map, may acquire information of a fixed background, and may detect, track, or predict the UE's movement by using the acquired information. The base station may identify that the LoS path between the E and the base station is currently blocked by using the range-Doppler map, and may further determine or predict whether the LoS path between the mobile UE and the base station is blocked.

A base station according to an embodiment may identify radar sensing information regarding a moving UE among radar signals by using a finite impulse response (FIR) filter that selectively transmits a specific frequency band. For example, the base station may further perform a procedure of removing a signal regarding a static object irrelevant to the moving UE by using a moving target indicator (MTI) filter.

In operation 420, the base station may acquire path component information regarding at least one path between the UE and the base station, based on radar sensing information. Specifically, path components may include the time delay of the path of movement of a signal reflected from the UE, the Doppler shift, and the angle of arrival.

In operation 430, the base station may select a first path, based on information, based on path component information regarding at least one path acquired, and the UE's movement information. The path components may include time delay, Doppler shift, and angle of arrival. The UE's movement information may include at least one of a range, a speed, and an angle. The base station may select, as the first path, the path having the largest path gain, based on path components of at least one path.

The base station may determine whether a LOS path between the base station and the UE is generated, according to the location where the UE is predicted to exist, based on the UE's movement information, and may select a first path from at least one path including the LoS path or the NLOS path, based on the determination result. To this end, the base station may use the background-related information identified in step 410. For example, the base station may determine or predict, based on the background-related information, whether the LoS path between the UE and the base station may be blocked in the future. In case that the base station determines that the LoS path is generated, the LoS path may be selected as the first path, and in case of determining that the LoS path is not generated, the NLOS path may be selected as the first path.

The base station may predict whether the LoS path between the base station and the UE may be blocked by determining whether the LoS path is generated at a location where the UE is predicted to exist. Specifically, the base station may determine or estimate whether a signal of the LoS path is blocked as the UE moves, and may preemptively determine or generate an optimized beam.

In step 440, the base station may determine a first beamforming vector, based on path component information corresponding to the first path. In the disclosure, a beamforming vector may include a function based on the time delay, Doppler shift, and angle of arrival among path components.

The base station may select path component information having the largest path gain and may determine a beamforming vector by using parameters (e.g., the Doppler shift, time delay, and angle of arrival) included in the selected path component information. Specifically, the base station may determine a beamforming vector which maximizes the path gain, as in Equation 1 below:

$$f ( t ) = {\sum }_{l = 1}^{L} {α}_{1} {e}^{- j 2 π ( {v}_{l} t + {τ}_{d} {f}_{c} )} {a}_{t} ( {θ}_{1} ) \qquad [ Equation 1 ]$$

In operation 450, the base station may perform communication by using the beam formed based on the first beamforming vector.

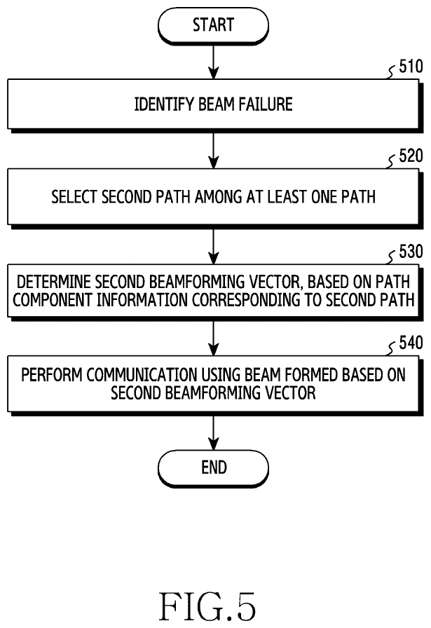

FIG. 5 illustrates a flowchart of a procedure of recovering a beam according to beam failure detection according to various embodiments of the present disclosure.

In step 510, the base station may detect or identify a beam failure. The beam identified to have failed may refer to a beam formed to correspond to the first path. In a beam management method based on laser sensing information according to an embodiment, the base station may detect a beam failure, based on laser sensing information regarding the UE. For example, in case that the NLOS path of a beam that has been used to communicate with the UE is blocked, the base station may detect a beam failure. Alternatively, the base station may form a map, based on radar information of the base station's surrounding environment, and may predict or detect that the link between the base station and the UE may be blocked, based on the formed map and the UE's movement information. To this end, the base station may determine the range and speed of the UE, based on radar information, and may predict or detect that the first path regarding the UE may be blocked.

According to a beam management method based on radar sensing information according to an embodiment, the base station may identify in advance whether the LoS path is blocked, without the UE's determining whether a beam failure condition is satisfied, or may predict the same based on the UE's movement information or the UE's location information.

In step 520, the second path may be selected from at least one path. The base station of the disclosure may determine, based on radar sensing information, information regarding multiple paths of the UE (e.g., one or fewer LoS path and one or more NLOS paths). Accordingly, even if beam blockage occurs due to an obstacle while performing communication using a beam formed in correspondence with the first path, the base station may immediately form a beam in a direction corresponding to the second path without a complicated beam recovery procedure. The first path and the second path may refer to one of multiple paths of the UE that the base station can identify, based on radar sensing information.

According to an embodiment, in the case that the first path is selected with reference to the path having the largest path gain among at least one path regarding the UE, the path having the second largest path gain may be selected as the second path.

According to an embodiment, in case that an LoS path or NLOS path is selected as the first path among at least one path regarding the UE, the second path may be an NLOS path. Obviously, the above example is not limiting.

In step 530, a second beamforming vector may be determined based on path component information corresponding to the second path. The beamforming vector may include a function based on the time delay, Doppler shift, and angle of arrival among the path components.

In step 540, communication may be performed by using a beam formed based on the second beamforming vector.

According to a beam management method according to an embodiment, the beam recovery procedure based on a CSI-RS of beam management methods, which is complicated and time-consuming, is replaced by a rapid beam vector determination and recovery procedure based on radar sensing information, thereby maximizing the data transmission rate while minimizing the loss of throughput and beamforming gain.

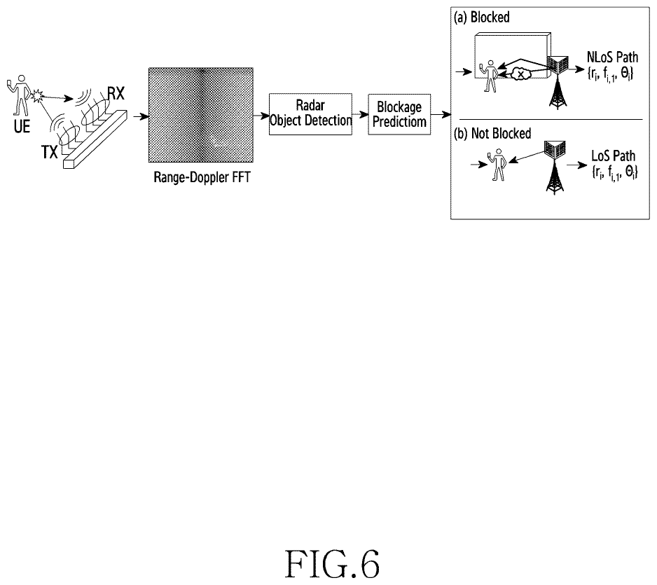

FIG. 6 illustrates a method of a base station predicts path blockage according to various embodiments of the present disclosure.

Referring to FIG. 6, the radar may transmit a chirp signal using a transmitter (TX) and may receive a signal reflected from the UE using a receiver (RX). The base station may acquire radar sensing information, based on the signal reflected from the UE and received through the radar. The base station may generate a range-Doppler map (RDM), based on the radar sensing information. In the disclosure, a range-speed response pattern may refer to the result of multiplying the Doppler shift value of the range-Doppler map by half the wavelength of the radar signal, and the wavelength may refer to the speed of light/central frequency.

The base station may perform object detection based on radar sensing information. Objects detected based on the radar sensing information may include moving objects and non-moving objects. The base station may identify information of the background, based on the range-Doppler map. For example, the base station may acquire information regarding a moving UE and non-moving reflectors or obstacles (e.g., buildings, walls, etc.) based on the range-Doppler map. The base station may generate an obstacle map, based on information regarding non-moving reflectors or obstacles.

Specifically, the base station may extract a background (e.g., a building, a tree, a wall) irrelevant to the UE by using the radar point cloud [symbol] . In general, the background is distant and motionless, the base station may thus estimate that, among rays (radio wave paths) facing in the same direction, the ray associated with the farthest radar point or data point is associated with the background.

The base station may acquire the UE's movement information or location information, based on the range-Doppler map. The UE's movement information may include at least one of the UE's speed, the range between the UE and the base station, and the angle between the UE and the base station. The base station may predict that the LoS path between the base station and the UE may be blocked at a specific future timepoint, based on the UE's movement information and/or location information and the obstacle map. Specifically, in case of determining that the UE is located farther than the background in the future, the base station may determine that the LoS path is blocked and, in the opposite case, may determine that the LoS path exists. For example, the future timepoint may include a time slot following the timepoint at which radar sensing information is acquired.

In case of determining that the LoS path of the UE is not blocked, the base station may form a beamforming vector, based on a path component corresponding to the LoS path. In case of determining that the LoS path of the UE is blocked, the base station may form a beamforming vector, based on a path component corresponding to one of NLOS paths. In this regard, the path having the largest path gain among the NLOS paths may be selected as a path for forming a beamforming vector.

According to an embodiment, in case of expecting LoS path signals may be blocked, the base station may form a beam in a direction corresponding to the NLOS path, thereby minimizing the possibility of that transmitted signals may be blocked.

According to an embodiment, the base station may form a beam and perform communication based on an LoS path, and may expect that LoS path signals may be blocked, as in the method illustrated in FIG. 6. Even if the UE performs no procedure of measuring the signal magnitude, detecting or determining a beam failure, and reporting the same to the base station, the base station may rapidly determine or predict a beam failure.

Alternatively, the method illustrated in FIG. 6 may be used by the base station to form a beam and perform communication, based on a specific NLOS path, and then to expect that the specific NLOS path may be blocked. In this case, the base station may form a beam and perform communication, based on the NLOS path, and may expect that NLOS path signals may be blocked, thereby quickly determining or predicting a beam failure.

FIG. 7 illustrates a method of a base station determines the range and speed of a UE based on radar sensing information according to various embodiments of the present disclosure.

The range-speed response pattern illustrated in FIG. 7 may indicate the range and speed of a target (e.g., a UE or a reflector) at the same time in a radar system. In the disclosure, the range-speed response pattern may be obtained by representing the result of target detection, which is acquired based on radar sensing information, on a 2D graph, the axes of which correspond to the range and speed, or a range-speed plane. Specifically, the range-speed response pattern may indicate the range to a target, which is determined based on the round-trip time of a radar signal, and the speed of a moving target, which is determined based on the Doppler effect. Through radar sensing information, the range-speed information of a target (a moving target and/or a stationary target) and information regarding the magnitude of a radar signal reflected by the target may be acquired.

The speed of a moving target may be acquired by using the following equation regarding the Doppler frequency: f_{d}=2vᵣ/λ, wherein f_{d} may indicate a Doppler frequency shift (Hz), vᵣ may indicate the relative speed (m/s) between the transmitter and the receiver, and λ may indicate the wavelength (m) of radio waves. For example, a background signal (or clutter) including signals reflected from a stationary target may have a relative speed of 0 m/s and a Doppler frequency shift of 0 Hz. For example, in case that the base station wants to acquire radar sensing information regarding a moving UE, the base station may use a filter to remove unnecessary background signals from all radar signals received through the radar receiver.

The base station may collect and preprocess signals (or radar sensing information) received from the radar, and may represent the target detection result on the range-speed plane on by using the fast Fourier transform (FFT), thereby generating the range-speed response pattern illustrated in FIG. 7. For example, points having range-speed values in the area 710 near the straight line of speed-0 m/s on the range-speed plane may indicate results of detecting stationary targets.

The range-speed response pattern illustrated in FIG. 7 may indicate the magnitude or power of signals together with the range-speed value of the target. Referring to FIG. 7, the base station may detect abnormal values, based on signal magnitude measurement values. For example, in the range-Doppler response pattern illustrated in FIG. 7, the base station may detect abnormal values, based on points in area 720 having higher signal magnitudes than other areas. Areas having higher signal magnitudes than other areas may indicate the existence of an object having a high radar signal reflectivity or an object having a relative speed. For example, points having range-speed values on in area 720 may indicate the result of detecting a target moving at a speed of about 10 m/s. Alternatively, in case that the target-related signal magnitude is strong, the base station may determine that signals reflected from the target have used a LoS path and/or an NLOS path. The base station may determine that signal propagation through the LoS path or NLOS path is possible, based on the magnitude of the reflected signal.

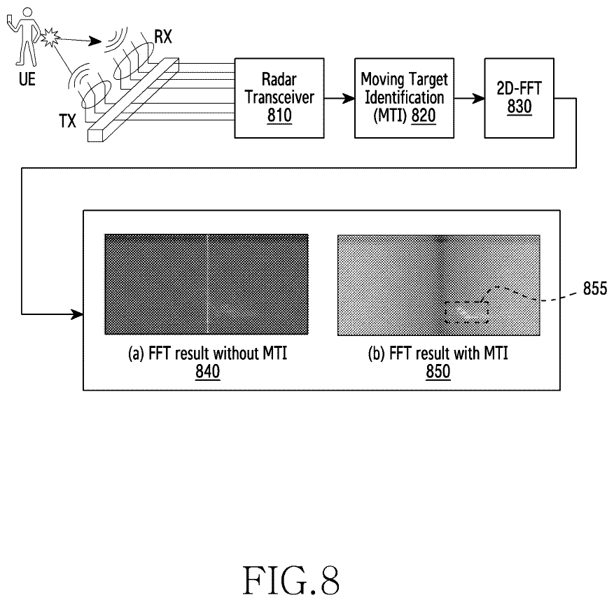

FIG. 8 illustrates a method of a base station to determine a range-Doppler map (RDM) regarding the range and speed of a UE based on radar sensing information according to various embodiments of the present disclosure.

Referring to FIG. 8, the radar may acquire radar sensing information through the transceiver 810. For example, the radar may transmit a signal (e.g., a chirp signal) through the transmitter (TX) and may receive a signal (e.g., a radar echo) that is reflected by a target and arrives at the radar through the receiver (RX). The reflected signal may include a signal reflected by the UE illustrated in FIG. 8 and a signal reflected by a different reflector.

The base station may acquire a reflected signal by using the radar, and may acquire radar sensing information by preprocessing the acquired signal. The radar sensing information may include range-speed information like the range-speed response pattern illustrated in FIG. 7. The radar sensing information may include a two-dimensional matrix configured by a range-speed or range-Dopler frequency axis (hereinafter, referred to as a “radar signal matrix R”). The elements of the radar signal matrix R may indicate the power of a signal corresponding to specific range and Doppler frequency. The radar sensing information may include a set of points in which range-speed information and information regarding the power of reflected signals are expressed in a three-dimensional space (hereinafter, referred to as a “point cloud P”). The point cloud P may include points having range-speed values and signal magnitude values, expressed on the range-speed response pattern illustrated in FIG. 7. According to an embodiment, the base station may extract a radar signal matrix R and/or a point cloud P from a radar signal. The base station may perform preprocessing of a signal received from the radar in order to acquire radar sensing information.

The base station may remove signals corresponding to static objects irrelevant to a moving target (e.g., a moving UE) by using an MTI filter 820, based on radar sensing information acquired by using a radar. For example, the base station may remove or suppress signals leaked between the transmitter (TX) and the receiver (RX) or signal reflected by stationary or slowly moving objects by using the MTI filter 820.

The base station may perform an FFT on the radar sensing information to acquire an FFT result. For example, the base station may generate FFT results 840 and 850 from radar sensing information by using a 2D-FFT 830.

In case that the base station does not perform filtering by using the MTI filter 820, but instead performs conversion by using the 2D-FFT 830, the acquired FFT result 840 may not strongly exhibit the pattern of a signal reflected from a moving UE, because background signals or clutters are not filtered. In case that the base station processes radar sensing information by using the MTI filter 820 and the FFT 830, clutters are filtered, and thus a pattern 855 of a signal reflected from a moving UE may be strongly shown, like the acquired FFT result 850. As such, the base station may accurately detect or track signals reflected from a moving UE by performing filtering by using the MTI filter 820.

According to an embodiment, the pattern 855 may be based on one or fewer LoS signal and one or more NLOS signals. The base station may identify the existence of a LOS path and an NLOS path regarding a moving UE, based on a pattern 855 acquired by FFT-transforming radar sensing information. The base station may more accurately detect the presence or absence of the LoS path and the NLOS path by using the MTI filter 820.

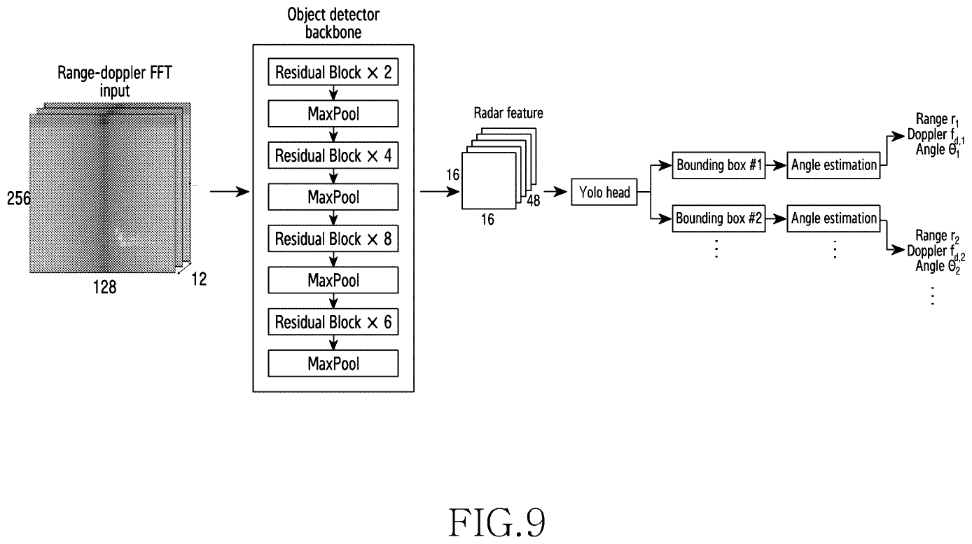

FIG. 9 illustrates a method of a base station to determine the time delay and Doppler shift regarding each of at least one path based on a range-Doppler map according to various embodiments of the present disclosure.

Referring to FIG. 9, the base station may acquire a path component regarding a target from radar sensing information by using a deep-learning-based path component estimation model. As illustrated in FIG. 8, the base station may use multiple FFT results acquired by FFT-transforming the radar sensing information as inputs to a deep learning-based path component estimation model.

The base station may use the object detector illustrated in FIG. 8 as a deep learning model. The base station may output feature maps of various sizes from multiple FFT results by using the backbone of the object detector. For example, the backbone of the object detector may output a radar feature map. The base station may determine the target's location, based on a radar feature map, by using the head of the object detector. The head of the object detector may receive a feature map extracted by the backbone as an input, process the same, and calculate class prediction and bounding box coordinates from images. For example, the head may include a you only look once (YOLO) head. The base station may determine multiple bounding boxes, based on the location of the target determined on the FFT results. The bounding box may indicate the location and size of objects inside images. The base station may calculate the angle (e.g., angle of departure or angle of arrival) of a path regarding the target, based on the bounding boxes. The base station may determine path components regarding the target, based on the bounding boxes and the calculated angle. For example, the path components may include the range, Doppler shift, and angle of arrival regarding the target. Alternatively, since the range regarding the target can be identified from the time delay, the path components may include the time delay, Doppler shift, and angle of arrival.

According to an embodiment, the base station may use an angle detection method using a MIMO radar (MIMO angle detection) to detect angles. The base station may acquire the angle of a path along which a radar signal is moving by performing an FFT with regard to a signal sampled from a reception antenna array by using a MIMO radar including multiple (e.g., Mt) transmission antennas and multiple (e.g., Mr) reception antennas. A convolution relation such as Equation 2 may be established with regard to a signal sampled from the receive antenna array.

$${a}_{M r} ( θ ) ⊗ {a}_{M t} ( ϕ ) = {a}_{MrMt} ( θ , ϕ ) \qquad [ Equation 2 ]$$

wherein a_{Mr}(θ) may indicate a directional pattern of a reception antenna array. a_{Mr}(θ) may refer to the angle of arrival (AOA).
a_{Mt} (φ) may indicate the directional pattern of a transmission antenna array. φ may refer to the angle of departure (AOD).

a_{MrMt} (θ) may indicate a combined response of the receiver and transmission antenna arrays. Alternatively, a_{MrMt} (θ, φ) may indicate an interaction between a reception antenna array and a transmission antenna array.

The symbol ⊗ denotes a convolution, and may indicate that the responses of the reception antenna array and the transmission antenna array are combined.

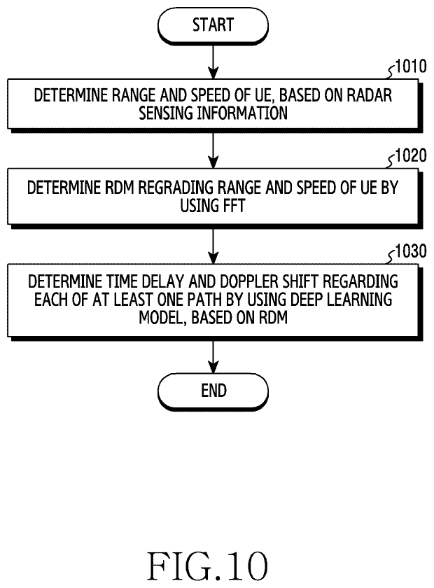

FIG. 10 illustrates a flowchart of a procedure of a base station to acquire path component information regarding at least one path between a UE and the base station based on radar sensing information regarding the UE according to various embodiments of the present disclosure.

In step 1010, the base station may determine the range and speed of the UE, based on radar sensing information.

In a beam management method based on radar sensing information according to an embodiment, the base station may preprocess a radar signal to acquire radar sensing information. The base station may extract a radar signal matrix R and a point cloud P from the radar signal.

Specifically, in case that an FMCW radar is used as the radar, the base station may acquire radar sensing information in the following method. The FMCW radar may transmit a chirp signal. The chirp signal may refer to a signal the frequency of which continuously varies over time. The FMCW radar may transmit a frame configured by N chirps every T_{F} seconds. The frequency of the chirp signal starts from the initial frequency f₀ and linearly increases by μ=B/T_{C} over time. In this regard, B and T_{C} indicate the bandwidth and time used by the chirp, respectively. A chirp signal transmitted from a transmission antenna of the FMCW radar may be received through the receiver of the FMCW radar. Reflected signals may be transferred along the LoS path or along at least one NLOS path together with the LoS path.

Assuming that the chirp signal transmitted by the radar is x(t), and the reflected signal received is y(t), the cross-correlation R(τ,v) between x(t) and y(t) may be expressed as follows.

$$R ( τ , v ) = {\int }_{- ∞}^{∞} ( x ( t ) y * ( t ) ) = α ( t ) exp ( i 2 π [ 2 ( v + k τ ) t + 2 τ fc ] ) \qquad [ Equation 3 ]$$

wherein v=f_{c}*v/c may indicate a Doppler shift, τ=R/c may indicate a time delay, α(t) may indicate a path loss, and k=B/T may indicate a sweep slope. The sweep slope may refer to the rate or speed at which a parameter, such as a frequency or a voltage, is changed for a predetermined period of time.

Using the Doppler shift and time delay that maximize the cross-correlation, the base station may acquire the speed and range of the target. Obviously, the above example is not limiting, and there are no limitations on the type of used radar and the method in which the base station acquires the target's range and speed according to signals transmitted and received by the radar.

The base station may preprocess a radar signal acquired through the radar. For example, the base station may acquire an intermediate frequency (IF) signal by passing a radar signal including the radar's transmission signal and reception signal through a quadrature mixer and a low-pass filter. The IF signal may be expressed as in Equation 4 below:

$${y}_{R} [ t , n ] = {\sum }_{l = 1}^{L} {b}_{l} exp ( j 2 π [ {f}_{r , l} t + {f}_{d , l} {T}_{C} n + {γ}_{l} ] ) \cdot a ( {θ}_{l} ) + w [ t , n ] \qquad [ Equation 4 ]$$

In Equation 4, with regard to the l^{th} path, f_{r,l}=2 μr/c may denote a range frequency, f_{d,l}=2f₀v/c may denote a Doppler frequency, γₗ=2 μvₗnT_{c}t/c may denote a Doppler combination component, or may denote the angle of arrival (AoA) to the UE, θₗ may denote the angle of departure (AoD), and a(θ)∈ [symbol] may denote a steering vector. [symbol] is a complex matrix of M×1 size.

The base station may sample the IF signal y_{R} at a sampling rate fₛ of the analog-to-digital converter (ADC) and may generate as many samples as N_{S} per chirp. In case that radar measurement is performed using M antennas and a chirp signal including as may chirps as N_{C} per frame, as many ADC samples as M·N_{C}·N_{S} may be generated. Each measurement's radar signal R may be expressed as R∈C^{M×N}^{_{C}}^{×N}^{_{S}}.

Because the radar signal R may be a mixture of a signal reflected from a moving terminal and a fixed background signal, the base station may extract or emphasize the signal RD of the moving object (e.g., UE) from the radar signal R by using an MTI filter, and may remove or suppress signals leaked between the transmitter and receiver or signals reflected from stationary or slowly moving objects (i.e., background signals or clutters). For example, the MTI filter may include a single delay MTI filter, and the single delay MTI filter may remove clutters by using the delay between a transmitted signal and a received signal.

Specifically, the base station may identify a moving UE by using the fact that, when a moving UE reflects a chirp signal, the frequency of the signal is changed according to the Doppler effect according to the speed of the UE, through the MTI filter. The MTI filter may remove background signal components from the received signal and extract only the signal reflected from the moving UE (signal filtering). The MTI filter is a type of finite impulse response (FIR) filter, which may selectively pass a specific frequency band and attenuate the rest, and may extract a signal the frequency band of which is changed according to the UE's movement. For example, the MTI filter may operate as a 2-tap FIR filter having high-pass characteristics.

In operation 1020, the base station may determine a range-Doppler map (RDM) regarding the range and speed of the UE, by using the fast Fourier transform (FFT). The base station may acquire the RDM in FIG. 8 by performing the FFT, based on the range-speed response pattern acquired in operation 1010. Referring to FIG. 8, the base station may identify the presence or absence of a path regarding the UE having a specific range and a specific Doppler frequency through the range-Doppler map.

Specifically, the base station may apply the 2-dimensional fast Fourier transform (2D-FFT) to R_D to generate a range-Doppler map (RDM). In this process, the base station may transform the radar signal in the range and Doppler frequency domains and express the same on the range-Doppler map to identify the location and speed of the UE. The 2D-FFT may intuitively visualize complex signals in the time-frequency domain and different pieces of range and speed information, thereby converting the same into a range-Doppler map which can be clearly identified.

$${R}_{R {D}_{( i , : , : )}} = {ℱ}_{2 D} \{ {R}_{{D}_{( i , : , : )}} \} \qquad [ Equation 5 ]$$

In Equation 5, in case that there is only a single path (LoS or NLoS) between the radar and the UE, the peak of the spectral power occurs at R_{RD(:,k,p)}, and k=N_{S}f_{r,l}/fₛ and p=N_{c}f_{d,l}T_{c}.

In operation 1030, the base station may determine the time delay and Doppler shift regarding each of at least one path by using a deep learning-based path component estimation model, based on the RDM. For example, the deep learning model may include a you only look once (YOLO) head.

Specifically, the base station may extract radar features related to the range and speed of the UE from the RDM through the backhaul architecture. The base station may predict an area in which the range and Doppler frequency of a signal reflected from an object (e.g., a moving UE) are displayed, through the head architecture. The base station may predict

$${\{ {k}_{l} , {p}_{l} , {w}_{l} , {h}_{l} \}}_{l = 1}^{\hat{L}}$$

by using a path component estimation model based on deep learning. \hat{L} is the number of estimated paths, kₗ is the range, pₗ is the Doppler frequency, and wₗ, hₗ refers to the scope of the range and Doppler frequency reflected by the UE.

The base station may acquire the range vₗ and speed vₗ of a path regarding the UE through reverse calculation of the operation process for acquiring kₗ and pₗ, based on range kₗ and Doppler frequency pₗ.

Finally, the base station may acquire or estimate angle information by using an angle detection method. For example, the base station may estimate the angle of arrival of a laser signal by using multiple signal classification (MUSIC) and estimation of signal parameters via rotational invariance techniques (ESPRIT) algorithms.

Specifically, the base station may extract information of a radar signal corresponding to range kₗ and Doppler frequency pₗ from the RDM. Information R_{RD,l}∈C^{M×W}^{ₗ}^{×H}^{ₗ} of the radar signal extracted from each path may be expressed as in Equation 6 below:

$${R}_{l} = {R}_{{RD}_{( : , {k}_{l} - \frac{{w}_{l}}{2} : {k}_{l} + \frac{{w}_{l}}{2} , {p}_{l} - \frac{{h}_{l}}{2} : {p}_{l} + \frac{{h}_{l}}{2} )}} \qquad [ Equation 6 ]$$

Rₗ may be expressed to be as many array response vector sequences as Wₗ·Hₗ, and the base station may apply an angle estimation algorithm thereto to estimate the angle θₗ of the signal received through the l^{th} path. MPC information estimated based on a radar signal is expressed as (rₗ, vₗ, θₗ), and the path corresponding to the shortest range rₗ may be classified as a LoS path, and the remaining paths may be classified as NLOS paths.

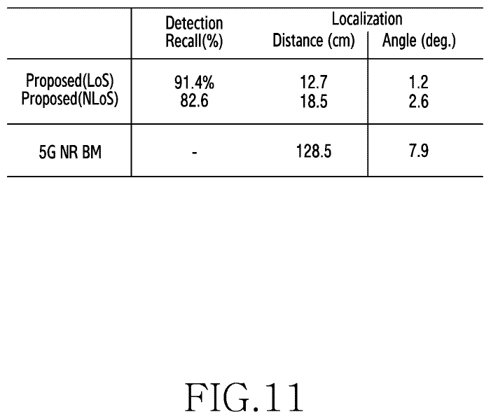

FIG. 11 illustrates performance improvement of a beam management method based on radar sensing information according to various embodiments of the present disclosure. The Proposed (LoS) data illustrated in FIG. 11 refers to a case in which the LoS path between the base station and the UE is determined based on radar sensing information, and a beamforming vector is determined based on the path components of the LoS path, and the Proposed (NLoS) data refers to a case in which the NLOS path between the base station and the UE is determined based on radar sensing information, and a beamforming vector is determined based on the path components of the NLOS path. 5G NR BM refers to a case in which a codebook-based beam management method is used.

Referring to FIG. 11, according to the beam management method based on radar sensing information, the detection recall, which is the probability of normally detecting the existence of a UE compared to the actual number of UEs, is 91.4% and 82.6% with regard to Proposed (LoS) and Proposed (NLoS), respectively. In addition, according to the codebook-based beam management method, the range from the UE has an error of 128.5 cm, and the angle of arrival has an error of about 7.9 degrees, but the accuracy in measurement and estimation is significantly improved to 12.7 cm and 1.2 degrees in the case of Proposed (LoS) and 18.5 cm and 2.6 degrees in the case of Proposed (NLoS).

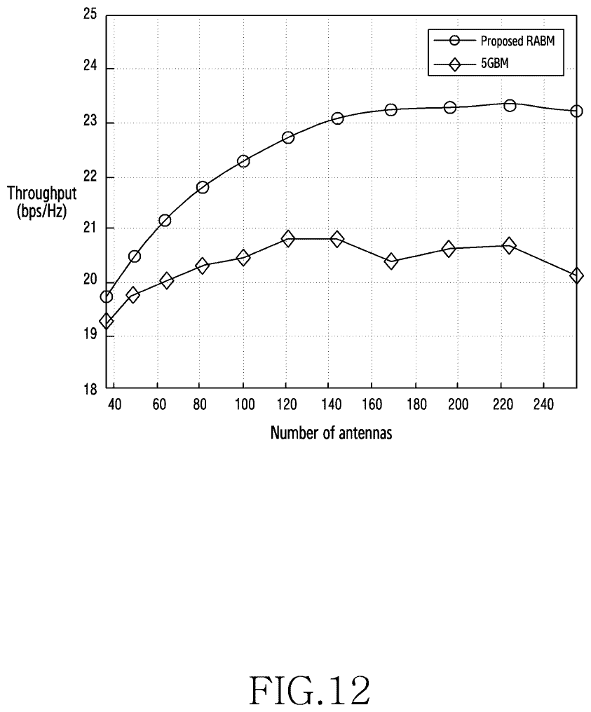

FIG. 12 illustrates performance improvement of a beam management method based on radar sensing information according to various embodiments of the present disclosure. Referring to FIG. 12, a change in the total throughput according to the number of antennas may be described in case that the total transmission power has a fixed value. According to FIG. 12, the total sum of throughput of the broken line graph of the radar-assisted beam management (RABM) is remarkably higher than that of the broken line graph of the 5G BM. As shown in FIG. 11, the beam management method based on radar sensing information of the disclosure allocates a highly accurate beam or an optimal beam, and may thus provide a high data transmission rate to the UE as shown in FIG. 12.

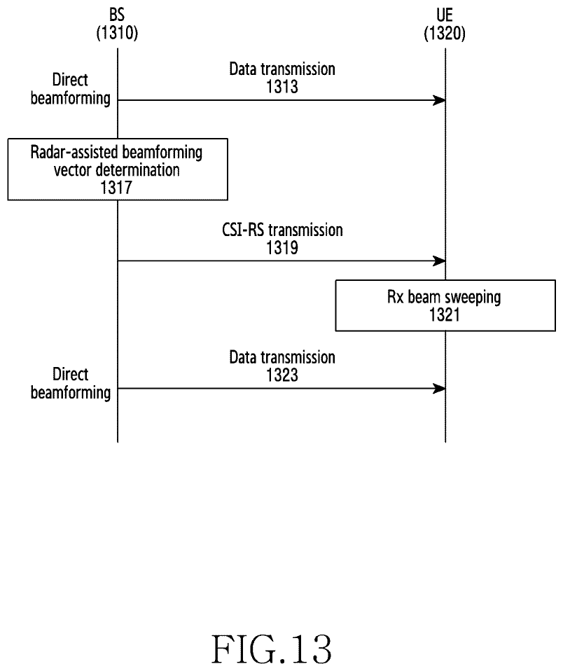

FIG. 13 illustrates a beam management method based on radar sensing information of a UE according to various embodiments of the present disclosure.

Referring to FIG. 13, according to the beam management method based on radar sensing information, the base station 1310 may perform transmission beamforming, transmit/receive data with the UE by using the formed beam (step 1313), and determine a beamforming vector based on the radar sensing information (step 1317). Additionally, the base station may perform a beam recovery procedure by determining a beamforming vector based on radar sensing information as described with reference to FIG. 5 upon detecting a beam failure as well.

That is, the base station may determine a transmission beam (determine a transmission beamforming vector) based on radar sensing information in order to determine the optimal transmission beam, and the UE may additionally perform beam sweeping in order to determine the optimal reception beam.

According to an embodiment, the UE may perform reception beam sweeping. The reception beam sweeping performed by the UE may mean that the UE's receiver is tuned in a specific direction. In this case, the base station may fix the beam, and the UE may perform a beam sweeping procedure. The UE may tune the UE's receiver to correspond to the beam formed by the base station in step 1317.

To this end, in step 1319, the base station may fix the beam, based on the beamforming vector determined in step 1317, and may repeatedly perform CSI-RS transmission. In step 1321, the UE may sweep a reception beam and measure the signal magnitude of the reception beam. The UE may select the beam having the maximum received signal magnitude and may start data communication with the base station. In case that the base station is informed of the reception beam on the UE side, the UE may transmit information of the reception beam to the base station through an uplink control signal before data communication.

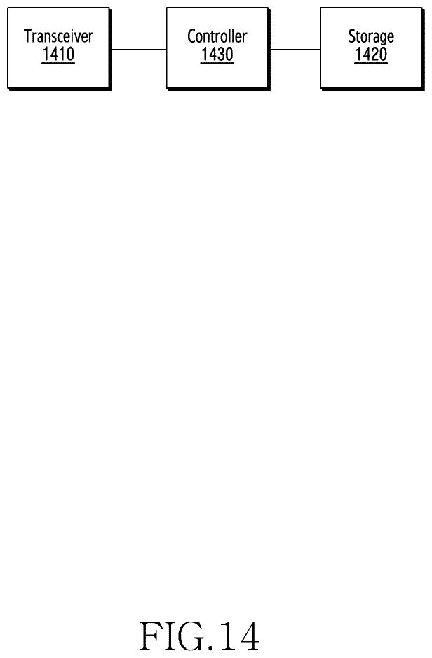

FIG. 14 illustrates an example of a structure of a UE according to various embodiments of the present disclosure.

As illustrated in FIG. 14, the UE of the disclosure may include a controller (control unit) 1430, a transceiver 1410, and a storage (memory) 1420. However, components of the UE are not limited to the above-described example. For example, the UE may include a larger or smaller number of components than the above-described components. In addition, the controller 1430, the transceiver 1410, and the storage 1420 may be implemented in the form of a single chip. The controller 1430 of FIG. 14 may include at least one processor or controller.

According to an embodiment, the controller 1430 may control a series of processes so that the UE can operate according to the above-described embodiments of the disclosure. For example, according to an embodiment of the disclosure, the controller 1430 may control the components of the UE to perform transmission and reception methods of the UE according to whether the base station mode is a base station power saving mode or a base station normal mode. The controller 1430 may include one or multiple controllers, and the controller 1430 may execute programs stored in the storage 1420 to perform transmission and reception operations of the UE in a wireless communication system employing the above-described carrier aggregation of the disclosure.

The transceiver 1410 may transmit/receive signals with base stations. The signals transmitted/received with base stations may include control information and data. The transceiver 1410 may include an RF transmitter configured to up-convert and amplify the frequency of transmitted signals, an RF receiver configured to low-noise-amplify received signals and down-convert the frequency thereof, and the like. However, this is only an embodiment of the transceiver 1410, and the components of the transceiver 1410 are not limited to the RF transmitter and the RF receiver. In addition, the transceiver 1410 may receive signals through a radio channel, output the same to the controller 1430, and transmit signals output from the controller 1430 through the radio channel.

According to an embodiment, the storage 1420 may store programs and data necessary for operations of the UE. In addition, the storage 1420 may store control information or data included in signals transmitted/received by the UE. The storage 1420 may include storage media such as a ROM, a RAM, a hard disk, a CD-ROM, and a DVD, or a combination of storage media. In addition, the storage 1420 may include multiple storages. According to an embodiment, the storage 1420 may store programs for performing transmission and reception operations of the UE according to whether the base station mode in the above-described embodiments of the disclosure is a base station power saving mode or a base station normal mode.

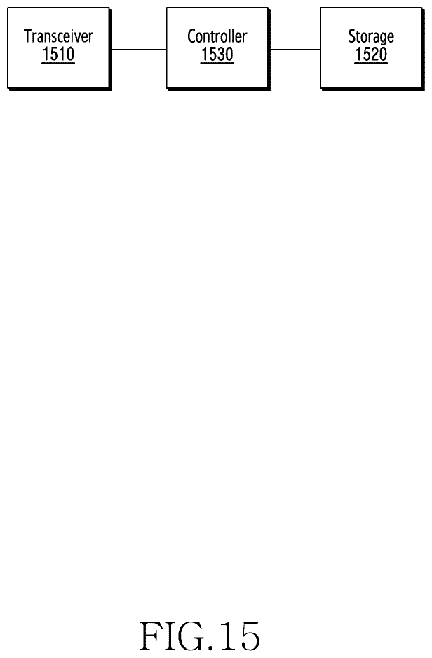

FIG. 15 illustrates an example of a structure of a base station according to various embodiments of the present disclosure.

As illustrated in FIG. 15, the base station of the disclosure may include a controller (control unit) 1530, a transceiver 1510, and a storage (memory) 1520. However, components of the base station are not limited to the above-described example. For example, the base station may include a larger or smaller number of components than the above-described components. In addition, the controller 1530, the transceiver 1510, and the storage 1520 may be implemented in the form of a single chip. The controller 1530 of FIG. 15 may include at least one processor or controller.

The controller 1530 may control a series of processes so that the base station can operate according to the above-described embodiments of the disclosure. For example, according to an embodiment of the disclosure, the controller 1530 may control the components of the base station to perform UE scheduling methods according to whether the base station mode is a base station power saving mode or a base station normal mode. The controller 1530 may include one or multiple controllers, and the controller 1530 may execute programs stored in the storage 1520 to perform UE scheduling methods according to whether the above-described base station mode is a base station power saving mode or a base station normal mode.

The transceiver 1510 may transmit/receive signals with UEs. The signals transmitted/received with UEs may include control information and data. The transceiver 1510 may include an RF transmitter configured to up-convert and amplify the frequency of transmitted signals, an RF receiver configured to low-noise-amplify received signals and down-convert the frequency thereof, and the like. However, this is only an embodiment of the transceiver 1510, and the components of the transceiver 1510 are not limited to the RF transmitter and the RF receiver. In addition, the transceiver 1510 may receive signals through a radio channel, output the same to the controller 1530, and transmit signals output from the controller 1530 through the radio channel.

According to an embodiment, the storage 1520 may store programs and data necessary for operations of the base station. In addition, the storage 1520 may store control information or data included in signals transmitted/received by the base station. The storage 1520 may include storage media such as a ROM, a RAM, a hard disk, a CD-ROM, and a DVD, or a combination of storage media. In addition, the storage 1520 may include multiple storages. According to an embodiment, the storage 1520 may store programs for performing UE scheduling methods according to whether the base station mode in the above-described embodiments of the disclosure is a base station power saving mode or a base station normal mode.

A beam management method based on radar sensing information according to various embodiments of the disclosure extracts precise location and direction information of a UE by utilizing a radar, and thus enables fast and accurate beamforming. In particular, in consideration of the characteristics of mm Wave band signals, the possibility of a beam failure in LOS and NLOS paths is predicted in advance, and various pieces of direction information are extracted to provide a function of readjusting a beam without blockage by obstacles. Accordingly, stable communication quality may be maintained even in a complex environment, and efficient beamforming may be implemented even in mmWave systems with a low overhead.

Although specific embodiments of the disclosure have been described to describe the technical idea of the disclosure in detail, individual operations that constitute each embodiment may be changed in order or partially omitted. Therefore, embodiments in which the order of operations is changed or some operations are omitted from each embodiment are to be understood as being described by the disclosure. In addition, embodiments of the disclosure may be variously modified by the content described in the disclosure.

Although operations of the method according to embodiments of the disclosure have been described separately for each embodiment, the operations included in each embodiment may be combined with the operations of other embodiments to form a new embodiment. Therefore, it is understood that embodiments obtained by combining embodiments of the disclosure are also described by the disclosure.

It should be appreciated that various embodiments of the disclosure and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively,” as “coupled with/to” or “connected with/to” another element (e.g., a second element), it means that the element may be coupled/connected with/to the other element directly (e.g., wiredly), wirelessly, or via a third element.

As used in various embodiments of the disclosure, the term “module” may include a unit implemented in hardware, software, or firmware, and may be interchangeably used with other terms, for example, “logic,” “logic block,” “component,” or “circuit.” The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., a program) including one or more instructions that are stored in a storage medium (e.g., an internal memory or external memory) that is readable by a machine (e.g., an electronic device). For example, a processor (e.g., the processor 230) of the machine (e.g., an electronic device) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a base station in a wireless communication system, the method comprising:
acquiring radar sensing information for a user equipment (UE);
acquiring, based on the radar sensing information, path component information for at least one path between the UE and the base station;
selecting a first path based on the path component information for the at least one path and movement information of the UE;
identifying a first beamforming vector based on first path component information corresponding to the first path; and
performing a communication using a beam formed based on the first beamforming vector.

2. The method of claim 1, wherein selecting the first path comprises:
determining, based on the movement information of the UE, whether a line-of-sight (LoS) path between the UE and the base station is generated based on a location at which the UE is predicted to exist; and
selecting, based on a determination result, the first path among at least one path comprising the LoS path or a non LoS (NLoS) path.

3. The method of claim 1, wherein a path gain of the first path includes a largest gain among path gains of the at least one path.

4. The method of claim 1, comprising:
detecting a beam failure for the beam based on the first beamforming vector;
selecting a second path among the at least one path;
determining a second beamforming vector based on second path component information corresponding to the second path; and
performing a communication using a beam formed based on the second beamforming vector.

5. The method of claim 4, wherein the first path is a line-of-sight (LoS) path or a non LoS (NLoS) path, and wherein the second path is the NLOS path.

6. The method of claim 1, wherein the path component information for the at least one path comprises a time delay, a Doppler shift, and an angle of arrival for each of the at least one path, and
wherein the movement information of the UE includes at least one of a speed of the UE, a range between the UE and the base station, and an angle between the UE and the base station.

7. The method of claim 1, wherein acquiring the path component information for the at least one path comprises:
acquiring, based on the radar sensing information, range information and speed information of the UE;
acquiring range-Doppler map (RDM) information for a range and a speed of the UE through a fast Fourier transform (FFT) operation; and
determining, based on the range-Doppler map, a time delay and a Doppler shift for each of the at least one path using a deep learning model.

8. The method of claim 7, further comprising identifying that each of the at least one path is a line-of-sight (LoS) path or a non-LoS (NLoS) path, based on the time delay, the Doppler shift, and an angle.

9. The method of claim 1, further comprising transmitting, to the UE, a synchronization/physical broadcast channel (PBCH) block (SSB),
wherein the SSB includes a physical cell identity (PCI) of the base station, cell group information, and system information (SI).

10. The method of claim 1, further comprising receiving information corresponding to the beam formed based on the first beamforming vector,
wherein the information corresponding to the beam is identified through a UE beam sweeping.

11. A base station in a wireless communication system, the base station comprising:
a transceiver; and
a controller operably connected to the transceiver, the controller configured to:
acquire radar sensing information for a user equipment (UE);
acquire, based on the radar sensing information, path component information for at least one path between the UE and the base station;
select a first path based on the path component information for the at least one path and movement information of the UE;
identify a first beamforming vector based on first path component information corresponding to the first path; and
perform a communication using a beam formed based on the first beamforming vector.

12. The base station of claim 11, wherein the controller is further configured to:
determine, based on the movement information of the UE, whether a line-of-sight (LoS) path between the UE and the base station is generated according to a location at which the UE is predicted to exist; and
select, based on a determination result, the first path among at least one path comprising the LoS path or a non-LoS (NLOS) path.

13. The base station of claim 11, wherein a path gain of the first path includes a largest gain among path gains of the at least one path.

14. The base station of claim 11, wherein the controller is further configured to:
detect a beam failure for the beam based on the first beamforming vector;
select a second path among the at least one path;
determine a second beamforming vector, based on second path component information corresponding to the second path; and
perform a communication using a beam formed based on the second beamforming vector.

15. The base station of claim 14, wherein the first path is a line-of-sight (LoS) path or a non-LoS (NLoS) path, and wherein the second path is the NLOS path.

16. The base station of claim 11, wherein the path component information for the at least one path comprises a time delay, a Doppler shift, and an angle of arrival for each of the at least one path, and
wherein the movement information of the UE includes at least one of a speed of the UE, a range between the UE and the base station, and an angle between the UE and the base station.

17. The base station of claim 11, wherein the controller is further configured to:
acquire, based on the radar sensing information, range information and speed information of the UE;
acquire range-Doppler map (RDM) information for a range and a speed of the UE through a fast Fourier transform (FFT) operation; and
determine, based on the range-Doppler map, a time delay and a Doppler shift for each of the at least one path using a deep learning model.

18. The base station of claim 17, wherein the controller is further configured to identify that each of the at least one path is a line-of-sight (LoS) path or a non-LoS (NLOS) path, based on the time delay, the Doppler shift, and an angle.

19. The base station of claim 11, wherein the controller is further configured to transmit, to the UE, a synchronization/physical broadcast channel (PBCH) block (SSB), and
wherein the SSB includes a physical cell identity (PCI) of the base station, cell group information, and system information (SI).

20. The base station of claim 11, wherein the controller is further configured to receive information corresponding to the beam based on the first beamforming vector, and
wherein the information corresponding to the beam is identified through UE beam sweeping.
